(19) United States
(12) Patent Application Publication
(10) Pub. No.: US 2014/0334352 A1
(43) Pub. Date: Nov. 13, 2014

(54) CELL CLUSTER COORDINATION

(71) Applicant: Teck Hu, Melbourne, FL (US)

(72) Inventor: Teck Hu, Melbourne, FL (US)

(73) Assignee: ALCATEL-LUCENT USA INC., Murray Hill, NJ (US)

(21) Appl. No.: 13/892,096

(22) Filed: May 10, 2013

(51) Int. Cl. H04W 16/18

(52) U.S. Cl. CPC H04W 16/18
USPC 370/280

(57) ABSTRACT

The present application describes embodiments of a method for coordinating cells in a cluster. One embodiment of the method includes sending, from a first base station, information identifying a first time division duplex (TDD) subframe configuration associated with the first base station. This embodiment of the method also includes receiving, at the first base station, an acknowledgment indicating that a second base station received the information. This embodiment of the method further includes sending, from the first base station and in response to receiving the acknowledgment, information indicating modification of the first TDD subframe configuration to a second TDD subframe configuration.

### BACKGROUND

1. Field of the Disclosure

The present disclosure relates generally to wireless communication systems and, in particular, to cell cluster coordination in wireless communication systems.

2. Description of the Related Art

Wireless communication systems typically include a variety of different types of cells deployed adjacent to each other or in an overlay configuration. For example, a heterogeneous wireless communication system may include macrocells for providing wireless connectivity over relatively large areas and one or more smaller cells for providing wireless connectivity over relatively small areas within the larger areas covered by the macrocells. The macrocells may include base stations, base station routers, and the like. The smaller cells may include low power nodes, microcells, femtocells, picocells, access points, home base station routers, and the like. The terms “cell,” “macrocell,” “microcell,” etc. are conventionally used to indicate both the physical device used to provide wireless connectivity and the coverage area of the wireless connectivity. Thus, the term “macrocell” may refer to a base station that provides wireless connectivity or the coverage area of the base station. User equipment can communicate with the wireless communication system over downlink (or forward link) channels that convey information from the network to the user equipment or uplink (or reverse link) channels that convey information from the user equipment to the network.

Wireless communication systems that implement standards such as the Long Term Evolution (LTE) Advanced standard can use time division duplexing (TDD) to allocate frames and subframes for uplink and downlink transmissions. For example, a base station in the wireless communication system that implements TDD may allocate subframes 0, 2, 4, 6, 8 to downlink transmission from the base station to user equipment and may allocate subframes 1, 3, 5, 7, and 9 to uplink transmissions from the user equipment to the base station. Different base stations can select different configurations of the uplink/downlink subframe allocation. For example, the LIT standard defines seven TDD subframe configurations and base stations can select from among these configurations. Some embodiments of the base stations may allocate larger numbers of TDD subframes to downlink transmissions for broadcasting large volumes of data to user equipment or they may allocate larger numbers of TDD subframes to uplink transmissions when receiving a large amount of data from user equipment.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a wireless communication system that includes a plurality of cells served by a corresponding plurality of base stations, according to some embodiments.

FIG. 2 illustrates a set of TDD subframe configurations adopted by base stations such as the base stations shown in FIG. 1, according to some embodiments.

FIG. 3 illustrates a heterogeneous wireless communication system that includes one or more macrocells and one or more overlaying small cells, according to some embodiments.

FIG. 4 illustrates a wireless communication system, according to some embodiments.

FIG. 5 is a diagram of a method used to coordinate TDD subframe configurations, according to some embodiments.

### DETAILED DESCRIPTION

Dynamically allocating time division duplex (TDD) subframes, e.g., on timescales of milliseconds or frame-by-frame, may allow a TDD spectrum operator to adapt to rapid changes in uplink or downlink traffic or channel conditions. However, dynamically changing the uplink/downlink TDD subframe allocation in different base stations can lead to serious interference if the different base stations are not coordinated. For example, a base station that allocates a subframe to uplink transmissions may experience strong interference from a neighboring base station that allocates the same subframe to downlink transmissions since in TDD systems share the same frequency on the uplink and downlink channels. For another example, user equipment that are served by abuse station that allocates a subframe to downlink transmissions may experience strong interference from user equipment served by a neighboring base station that allocates the same subframe to uplink transmissions. This problem can be exacerbated in heterogeneous wireless communication systems that include combinations of macrocells and smaller cells that may be deployed by different vendors that may not coordinate operations of their networks.

At least in part to support dynamic allocation of TDD subframes and to reduce interference between base stations and user equipment, the present application describes embodiments of base stations that can negotiate with each other to decide whether to form a cluster and coordinate allocation of their TDD subframes. For example, a first base station may send information identifying its current or future TDD subframe configuration to one or more second base stations, e.g., base stations that may cause strong interference at the first base station in one or more subframes. The second base station(s) may acknowledge receipt of the information, thereby forming a cluster relationship with the first base station. The first and second base stations may then exchange TDD subframe configurations in the event that any of the TDD subframe configurations change. When a base station receives information indicating that a TDD subframe configuration of one of the base stations in its cluster has changed or is going to change, the base station can use this information to decide whether to change its own TDD subframe configuration or implement other interference mitigation techniques in the conflicting subframes. Some embodiments may form the clusters in a distributed manner using peer-to-peer negotiations between individual base stations

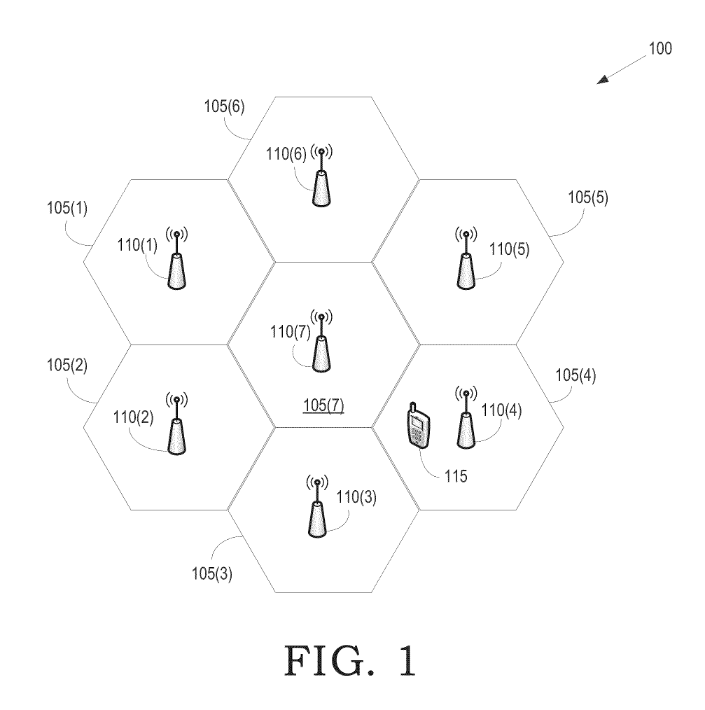

FIG. 1 illustrates a wireless communication system 100 that includes a plurality of cells 105 served by a corresponding plurality of base stations 110, according to some embodiments. The base stations 110 in the wireless communication system 100 may provide wireless connectivity to one or more user equipment 115 according to wireless communication standards including the Universal Mobile Telecommunications Standards (UMTS), Long Term Evolution (LTE), or other standards defined by the Third Generation Partnership Project (3GPP, 3GPP2) or other standard-setting organizations. Persons of ordinary skill in the art having benefit of the present disclosure should appreciate that wireless connectivity may be provided to the cells by other devices such as base station routers, access points, home base station routers, low power nodes, microcells, femtocells, picocells, and the like. Moreover, in accordance with common usage in the art, the term “cell” may be used to refer to both the geographic area served by a base station 110 and the base station 110 itself.

The base stations 110 may provide wireless communication to user equipment 115 using time division duplexing (TDD). For example, each transmission frame may be divided into a set of subframes and then each subframe may be used for either uplink or downlink communication. A. TDD subframe configuration may be used to determine the allocation of the subframes to uplink or downlink communication. For example, each base station 110 may choose a TDD subframe configuration from a set of predetermined or standardized configurations. The TDD subframe configurations may be modified semi-statically, or dynamically, e.g., on a timescale of milliseconds or on a frame-by-frame basis. The base stations 110 may modify the TDD subframe configurations based on changing uplink or downlink traffic, changing uplink or downlink channel conditions, and the like.

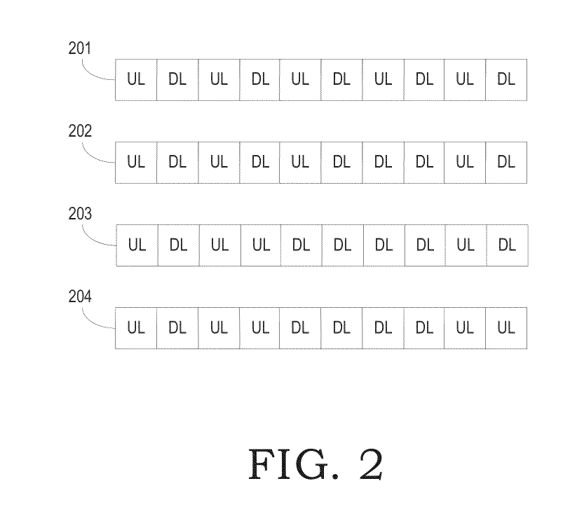

FIG. 2 illustrates a set of TDD subframe configurations adopted by base stations, such as the base stations 110 shown in FIG. 1, according to some embodiments. The illustrated embodiment shows the TDD subframe configuration for one frame 201-204 for a plurality of base stations in a cluster. The frames may be transmitted concurrently by the four base stations. Although frames 201-204 associated with four base stations are shown in FIG. 2, the number of base stations in a cluster can vary depending on the deployment scenario, channel conditions, or for other reasons. Each frame 201-204 includes ten subframes (0-9) that can be allocated to uplink (UL) or downlink (DL) transmissions. For example, each of the frames 201-204 allocates subframe 0 to uplink transmission, subframe 1 to downlink transmissions, and subframe 2 to uplink transmission. However, the allocation of some of the other subframes to uplink or downlink transmission may differ for the different base stations. For example, subframe 3 in frames 201-202 are allocated to downlink transmissions and subframe 3 in frames 203-204 are allocated to uplink transmissions. As discussed herein, these conflicting TDD subframe configurations can lead to significant interference between base stations or user equipment served by the base stations.

Referring back to FIG. 1, one or more of the cells 115 may be grouped into clusters and cells 115 within a cluster may coordinate their TDD subframe allocations. Some embodiments of a cluster may contain cells 115 with the same UL/DL transmission direction in all subframes or in a subset of subframes. Some embodiments of a cluster may alternatively contain cells 115 that have the same UL/DL transmission directions in a threshold number of subframes. For example, cells 115 may be grouped into a cluster so that at least 50% of the subframes have the same UL/DL transmission directions. Interference between the cells 115 may be reduced or mitigated by clustering cells that may interfere strongly with each other. For example, the base stations 110 may be able to exchange messages to negotiate with each other and decide whether to form a cluster.

Base stations 110 that agree to cluster together may coordinate allocation of their TDD subframes. For example, if base station 110(7) estimates that conflicts with the TDD subframe configurations of base stations 110(1-6) could cause strong interference at the base station 110(7), the base station 110(7) may form a cluster with the base stations 110(1-6) so that the base stations 110(1-7) agree to inform the others when their TDD subframe configurations are modified or may be modified in the future. When one of the base stations 110 receives information indicating that the TDD subframe configuration of another base station 110 has been modified or may be modified, the base station 110 can decide whether to adapt its TDD subframe configuration to conform more closely to the new TDD subframe configuration of the other base station. For example, the notified base station 110 may modify its own TDD subframe configuration to be the same (or partially the same) as the new TDD subframe configuration. The base station 110 may also decide whether to perform other interference mitigation procedures.

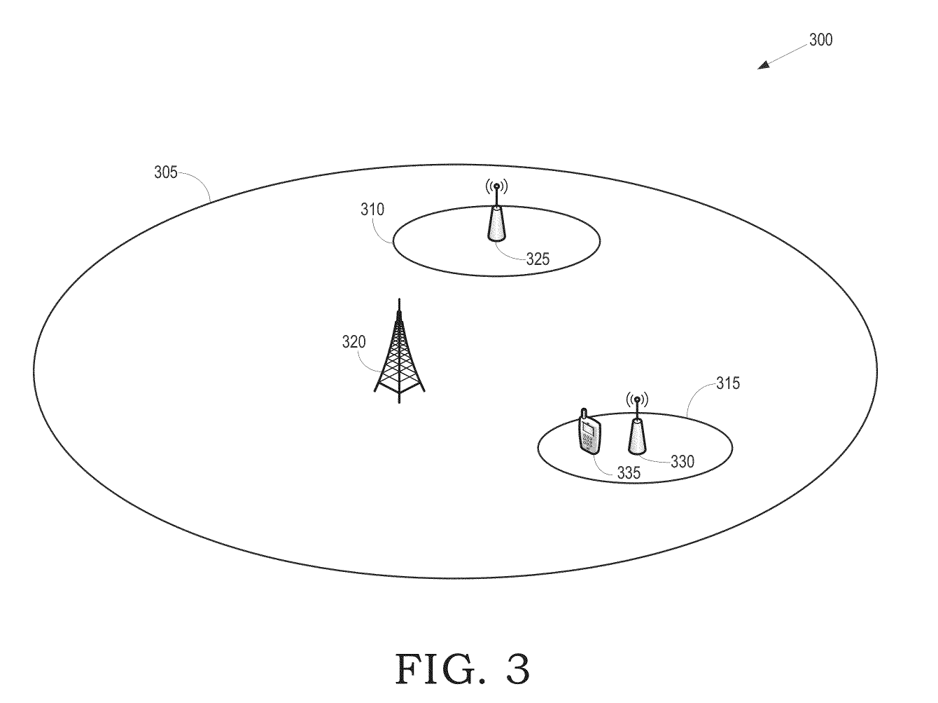

FIG. 3 illustrates a heterogeneous wireless communication system 300 that includes one or more macrocells is 305 and one or more overlaying small cells 310 and 315, according to some embodiments. The macrocell 305 is served by a base station 320 or other device capable of providing wireless connectivity to the macrocell 305. However, in accordance with common usage in the art, the term “macrocell” may be used to refer to both the geographic area served by the base station 320 and the base station 320 itself. The same convention may be applied to the overlaying small cells 310 and 315, which may be served by one or more access points 325, 330 or other devices capable of providing wireless connectivity to the cells 310, 315. The cells 305, 310, 315 in the heterogeneous wireless communication system 300 may provide wireless connectivity according to wireless communication standards or protocols including the Universal Mobile Telecommunications Standards (UNITS), Long Term Evolution (LTE), or other standards defined by the Third Generation Partnership Project (3GPP, 3GPP2) or other standard-setting organizations.

The cells 305, 310, 315 implement TDD communication with one or more user equipment 335. As discussed herein, conflicting TDD subframe configurations in the cells 305, 310, 315 can lead to significant interference between the cells 305, 310, 315 or user equipment served by the cells 305, 310, 315. The inter-cell interference may be exacerbated in a heterogeneous wireless communication system 300 because the cells 305, 310, 315 are deployed in an overlay configuration. Interference between the cells 305, 310, 315 may be reduced or mitigated by clustering cells that may interfere strongly with each other. For example, the cells 305, 310, 315 may be able to exchange messages to negotiate with each other and decide whether to form a cluster. Cells 305, 310, 315 within a cluster may then notify each other about current or impending changes in their TDD subframe configurations so that the other cells 305, 310, 315 can decide whether to modify their own TDD subframe configurations and/or perform other interference mitigation.

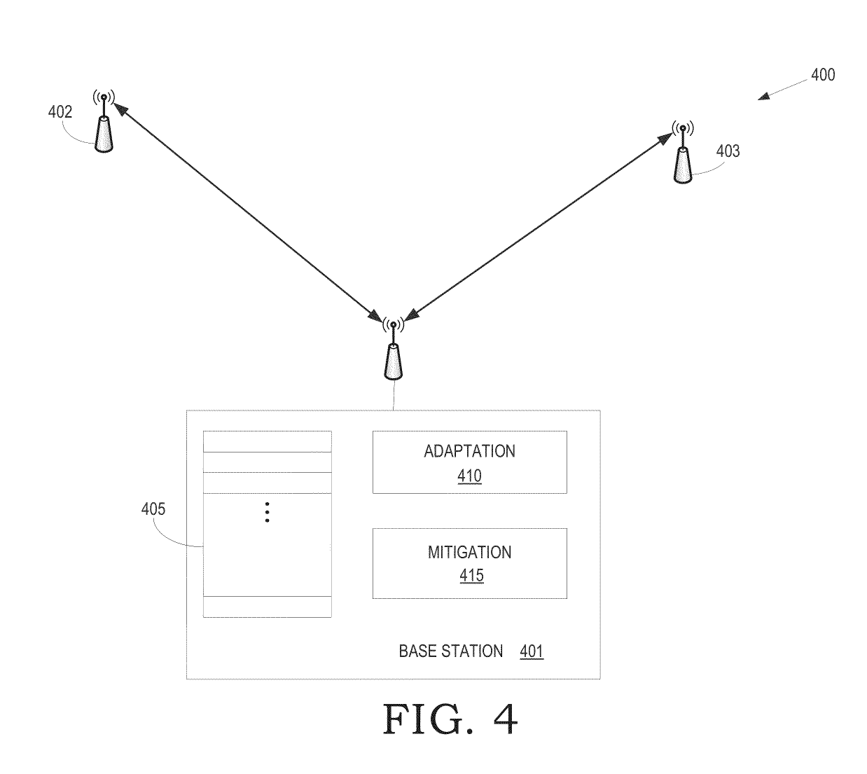

FIG. 4 illustrates a wireless communication system 400, according to some embodiments. The wireless communication system 400 includes base stations 401-403. Although three base stations are depicted in FIG. 4, persons of ordinary skill in the art having benefit of the present disclosure should appreciate that this number is illustrative and other embodiments of the wireless communication system 100 may include more or fewer base stations. The components of base station 401 are shown in more detail than the components of base stations 402, 403, but persons of ordinary skill in the art having benefit of the present disclosure should appreciate that some embodiments of the base stations 402, 403 may include components that perform substantially the same functions as the components shown in base station 401.

The base stations 401-403 may form a cluster and agree to coordinate their TDD subframe configurations. For example, the base station 401 may send a request to the base station 402 that includes a TDD subframe configuration, thereby indicating that the base station 401 is asking the base station 402 to form a cluster. This differs from the conventional practice because a conventional base station does not interpret receipt of TDD subframe configuration information as a request to establish a cluster. The base station 402 may acknowledge the request, e.g., because the base station 402 has identified the base station 401 as a potentially strong interferer, and the base stations 401-402 may form a cluster. The base station 401 may therefore store information identifying the base station 402 in a data structure such as a table 405. Entries in the data structure 405 may also include information identifying the current TDD subframe configuration of the base station 402, signal strength or interference level information associated with the base station 402, or other information. For another example, the base station 403 may send a request to the base station 401 that includes a TDD subframe configuration to indicate that the base station 403 is asking the base station 401 to form a cluster. The base station 401 may acknowledge the request and store information identifying the base station 403 in the table 405. The base stations 401 and 403 may then form a cluster and agree to exchange TDD subframe configuration information.

In the event that one or more of the base stations 402-403 in the cluster signal the base station 401 to indicate a modified TDD subframe configuration or a future modification of a TDD subframe configuration, adaptation logic 410 in the base station 401 may use information in the table 405 to decide whether to modify the TDD subframe configuration used by the base station 401. Some embodiments of the adaptation logic 410 may implement algorithms that select modifications to the TDD subframe configuration based on the TDD subframe configuration used by the base station 401, the modified TDD subframe configuration, TDD subframe configurations of other base stations in the duster, signal strength information associated with the other base stations in the cluster, or other information. For example, the adaptation logic 410 may change the TDD subframe configuration of the base station 401 to match the TDD subframe configuration of the base station 403 as long as this does not lead to excessive interference due to conflicts with the TDD subframe configuration of the base station 402. For another example, the adaptation logic 410 may change the UL/DL direction for one or more of the TDD subframes used by the base station 401 if an estimate of the interference in those TDD subframes caused by conflict with one or more of the base stations 402, 403 exceeds a threshold. The estimate maybe based on previous signals received from the base stations 402, 403, pilot signals received from the base stations 402, 403, common reference signals received from the base stations 402, 403, or using other techniques.

The base station 401 also includes mitigation logic 415 that can be used to select and apply interference mitigation, e.g., to mitigate the effects of interference caused by conflicts between different TDD subframe configurations. For example, if there is a TDD subframe conflict between the base station 401 and the base station 402 in one or more subframes, the mitigation logic 415 may select and apply one or more interference mitigation techniques in the conflicting subframes. Mitigation techniques may include transmission of almost blank subframes in the conflicting subframes, power reduction for transmissions in the conflicting subframes, or other interference mitigation techniques such as backhaul coordination to inform other cells of severe inter-base-station interference. For example, a base station that is experiencing high interference may inform other base stations in the cluster that are the source of interference to enable and initiate interference mitigation techniques. In some embodiments, adaptation logic 410 and mitigation logic 415 may work together to determine an optimal combination of modifying the TTD subframe configuration to change the transmission direction in a subset of subframes and performing interference mitigation in another subset of subframes.

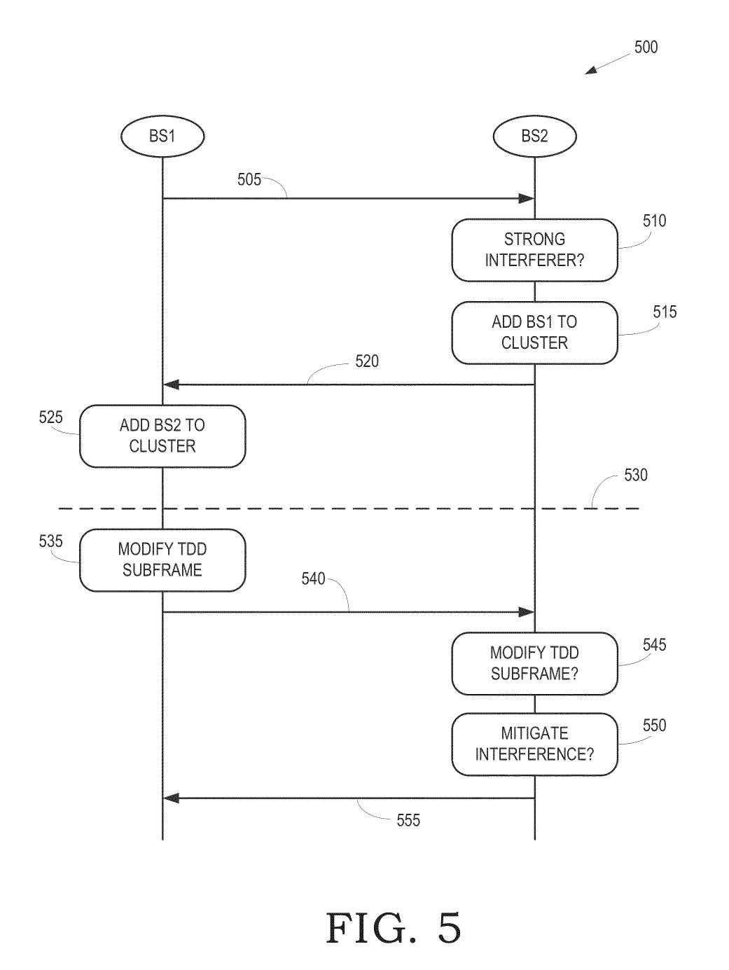

FIG. 5 is a diagram of a method 500 used to coordinate TDD subframe configurations, according to some embodiments. The method 500 depicts actions and messages exchanged by two base stations (BS1, BS2). The first base station sends (at 505) a request to form a cell cluster with the second base station. The request indicates the TDD subframe configuration currently being used by the first base station, Some embodiments of the first base station may transmit the request in the form of an information element (IE) that contains cell configuration information and can be transmitted over an X2 application protocol (AP) interface such as defined by 3GPP Technical Specification 36.423. Table 1 shows one embodiment of an IE that can be used to request formation of a cell cluster by transmitting TDD subframe configuration information. For example, the IE may be modified to change the IE/Group Name of the Subframe Assignment field to a Subframe Assignment & Cluster Request field, as shown below.

TABLE 1

| | | | IE type and | Semantics | | Assigned |
|---|---|---|---|---|---|---|
| IE/Group Name | Presence | Range | reference | description | Criticality | Criticality |
| PCI | M | | INTEGER | Physical Cell ID | — | — |
| | | | (0 . . . 503, . . .) | | | |
| Cell ID | M | | ECGI | | — | — |
| | | | 9.2.14 | | | |
| TAC | M | | OCTET | Tracking Area | — | — |
| | | | STRING(2) | Code | | |
| Broadcast PLMNs | | 1 . . . <maxnoof | | Broadcast | — | — |
| | | BPLMNs> | | PLMNs | | |
| >PLMN Identity | M | | 9.2.4 | | — | — |
| CHOICE EUTRA-Mode-Info | M | | | | — | — |
| >FDD | | | | | | |
| >>FDD info | | 1 | | | — | — |
| >>>UL EARFCN | M | | EARFCN | Corresponds to | — | — |
| | | | 9.2.26 | N_{UL} in TS | | |
| | | | | 36.104 [16] for | | |
| | | | | E-UTRA | | |
| | | | | operating bands | | |
| | | | | for which it is | | |
| | | | | defined; ignored | | |
| | | | | for E-UTRA | | |
| | | | | operating bands | | |
| | | | | for which N_{UL} is | | |
| | | | | not defined | | |
| >>>DL EARFCN | M | | EARFCN | Corresponds to | — | — |
| | | | 9.2.26 | N_{DL} in TS | | |
| | | | | 36.104 [16] | | |
| >>>UL Transmission | M | | Transmission | Same as DL | — | — |
| Bandwidth | | | Bandwidth | Transmission | | |
| | | | 9.2.27 | Bandwidth in | | |
| | | | | this release; | | |
| | | | | ignored in case | | |
| | | | | UL EARFCN | | |
| | | | | value is ignored | | |
| >>>DL Transmission | M | | Transmission | | — | — |
| Bandwidth | | | Bandwidth | | | |
| | | | 9.2.27 | | | |
| >>>UL EARFCN | O | | EARFCN | If this IE is | YES | reject |
| Extension | | | Extension | present, the | | |
| | | | 9.2.65 | value signalled | | |
| | | | | in the UL | | |
| | | | | EARFCN IE is | | |
| | | | | ignored. | | |
| >>>DL EARFCN | O | | EARFCN | If this IE is | YES | reject |
| Extension | | | Extension | present, the | | |
| | | | 9.2.65 | value signalled | | |
| | | | | in the DL | | |
| | | | | EARFCN IE is | | |
| | | | | ignored. | | |
| >TDD | | | | | — | — |
| >>TDD Info | | 1 | | | — | — |
| >>>EARFCN | M | | 9.2.26 | Corresponds to | — | — |
| | | | | N_{DL}/N_{UL} | | |
| | | | | in TS 36.104 [16] | | |
| >>>Transmission | M | | Transmission | | — | — |
| Bandwidth | | | Bandwidth | | | |
| | | | 9.2.27 | | | |
| >>>Subframe | M | | ENUMERATED | Uplink-downlink | — | — |
| Assignment & Cluster | | | (sa0, sa1, sa2, | subframe | | |
| Request | | | sa3, sa4, sa5, | configuration | | |
| | | | sa6, . . .) | information | | |
| | | | | defined in TS | | |
| | | | | 36.211 [10] | | |
| >>>Special | | 1 | | Special | — | — |
| Subframe Info | | | | subframe | | |
| | | | | configuration | | |
| | | | | information | | |
| | | | | defined in TS | | |
| | | | | 36.211 [10] | | |
| >>>>Special | M | | ENUMERATED | | — | — |
| Subframe Patterns | | | (ssp0, ssp1, | | | |
| | | | ssp2, ssp3, | | | |
| | | | ssp4, ssp5, | | | |
| | | | ssp6, ssp7, | | | |
| | | | ssp8, . . .) | | | |
| >>EARFCN Extension | O | | 9.2.65 | If this IE is | YES | reject |
| | | | | present, the | | |
| | | | | value signalled | | |
| | | | | in the EARFCN | | |
| | | | | IE is ignored. | | |
| >>>>Cyclic Prefix | M | | ENUMERATED | | — | — |
| DL | | | (Normal, | | | |
| | | | Extended, . . .) | | | |
| Cyclic Prefix | M | | ENUMERATED | | — | — |
| UL | | | (Normal, | | | |
| | | | Extended, . . .) | | | |
| >>>Additional | O | | | Special | GLOBAL | ignore |
| Special Subframe | | | | subframe | | |
| Info | | | | configuration | | |
| | | | | information | | |
| | | | | defined in TS | | |
| | | | | 36.211 [10]. | | |
| | | | | Only for newly | | |
| | | | | defined | | |
| | | | | configuration of | | |
| | | | | special | | |
| | | | | subframe from | | |
| | | | | Release 11. | | |
| >>>>Additional | M | | ENUMERATED | | — | — |
| Special Subframe | | | (ssp0, ssp1, | | | |
| Patterns | | | ssp2, ssp3, | | | |
| | | | ssp4, ssp5, | | | |
| | | | ssp6, ssp7, | | | |
| | | | ssp8, ssp9, . . .) | | | |
| >>>>Cyclic Prefix | M | | ENUMERATED | | — | — |
| DL | | | (Normal, | | | |
| | | | Extended, . . .) | | | |
| >>>>Cyclic Prefix | M | | ENUMERATED | | — | — |
| UL | | | (Normal, | | | |
| | | | Extended, . . .) | | | |
| Number of Antenna Ports | O | | 9.2.43 | | YES | ignore |
| PRACH Configuration | O | | PRACHConfiguration | | YES | ignore |
| | | | 9.2.50 | | | |
| MBSFN | | 0 . . . | | MBSFN | GLOBAL | ignore |
| Subframe Info | | <maxnoofMB | | subframe | | |
| | | SFN> | | defined in TS | | |
| | | | | 36.331 [9] | | |
| >Radioframe Allocation | M | | ENUMERATED | | — | — |
| Period | | | (n1, n2, n4, n8, | | | |
| | | | n16, n32, . . .) | | | |
| >Radioframe Allocation | M | | INTEGER (0 . . . 7, | | — | — |
| Offset | | | . . .) | | | |
| >Subframe Allocation | M | | 9.2.51 | | — | — |
| CSG ID | O | | 9.2.53 | | YES | ignore |
| MBMS Service Area | | 0 . . . | | Supported | GLOBAL | ignore |
| Identity List | | <maxnoofMB | | MBMS Service | | |
| | | MSServiceAr | | Area Identities | | |
| | | eaIdentities > | | in the cell | | |
| >MBMS Service Area | | | OCTET | MBMS Service | | |
| Identity | | | STRING(2) | Area Identities | | |
| | | | | as defined in TS | | |
| | | | | 23.003 [29] | | |
| MultibandInfoList | O | | 9.2.60 | | YES | ignore |

The second base station can receive the request and use the information in the request to decide whether to accept the request to form the cell cluster. Some embodiments of the second base station can determine (at 510) whether the first base station is likely to be a strong interferer, e.g., in the event of a TDD subframe configuration conflict. A second base station may then decide (at 515) to add the first base station to its cluster. Although the illustrated embodiment of the second base station makes this decision based in part on whether the first base station is likely to be a strong interferer, other criteria may be used instead of or in addition to this criterion. The second base station then acknowledges (at 520) receipt of the request from the first base station, thereby indicating that the second base station has formed a cluster with the first base station. The first base station may then add (at 525) the second base station to its cluster. At the point indicated by the line 530, the first and second base stations have agreed to form a cluster and to inform each other in the event that their TDD subframe configurations have changed or are expected to change.

The first base station modifies (or decides that it may modify) its TDD subframe configuration at 535. Since modifying the TDD subframe configuration may cause significant interference at other base stations, the first base station notifies other base stations in its cluster. For example, the first base station sends (at 540) a notification to the second base station including information indicating the modified TDD subframe configuration. Some embodiments of the first base station may use the if shown in Table 1 to convey this information. In response to receiving the notification, the second base station decides (at 545) whether to modify its own TDD subframe configuration. Modification of the TDD subframe configuration may include changing its TDD subframe configuration to match the TDD subframe configuration of the first base station, changing the transmission direction of selected subframes to correspond to the transmission direction in the same subframes of the modified TDD subframe, or doing nothing. The second base station may also decide at 550) whether to mitigate interference in one or more subframes indicated in the modified TDD subframe configuration. The second base station may then notify (at 555) the first base station of modifications (if any) to the second base station's TDD subframe configuration.

Some embodiments of the method 500 may be implemented as part of a peer-to-peer negotiation between the first and second base stations. For example, the first and second base stations may negotiate the cluster relationship without any additional controller coordination by a central controller. Thus, the establishment of clusters may be performed in a distributed manner and not a hierarchical manner, Clusters formed in a distributed manner as described herein may be referred to as “loose” clusters.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)). The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
sending, from a first base station, information identifying a first time division duplex (TDD) subframe configuration associated with the first base station; and
sending, from the first base station and in response to receiving an acknowledgment indicating that a second base station received the information, information indicating modification of the first TDD subframe configuration to a second TDD subframe configuration.

2. The method of claim in 1, wherein receiving the acknowledgment comprises receiving the acknowledgment in response to the second base station determining that the first base station is a strong interferer at the second base station.

3. The method of claim 1, comprising receiving information indicating modification of a third TDD subframe configuration associated with the second base station to a fourth TDD subframe configuration.

4. The method of claim 3, comprising using at least a portion of the fourth TDD subframe configuration at the first base station in response to estimated interference from the second base station exceeding a threshold.

5. The method of claim 3, comprising performing interference mitigation for at least a portion of the subframes at the first base station in response to estimated interference from the second base station exceeding a threshold.

6. The method of claim 1, comprising receiving information identifying a fifth time TDD subframe configuration associated with a third base station.

7. The method of claim 6, comprising acknowledging receipt of the information identifying the fifth TDD subframe configuration in response to identifying the third base station as a strong interferer.

8. The method of claim 7, comprising receiving information indicating modification of the fifth TDD subframe configuration to a sixth TDD subframe configuration.

9. The method of claim 8, comprising using at least a portion of the sixth TDD subframe configuration at the first base station in response to estimated interference from the third base station exceeding a threshold.

10. The method of claim 8, comprising performing interference mitigation for at least a portion of the subframes at the first base station in response to the estimated interference from the third base station exceeding a threshold.

11. A first base station configurable to:
send information identifying a first time division duplex (TDD) subframe configuration associated with the first base station;
receive an acknowledgment indicating that a second base station received the information; and
send, in response to receiving the acknowledgment, information indicating modification of the first TDD subframe configuration to a second TDD subframe configuration.

12. The first base station of claim 11, wherein the first base station is configurable to receive the acknowledgment in response to the second base station determining that the first base station is a strong interferer at the second base station.

13. The first base station of claim 11, wherein the first base station is configurable to receive information indicating modification of a third TDD subframe configuration associated with the second base station to a fourth TDD subframe configuration.

14. The first base station of claim 13, wherein the first base station is configurable to use at least a portion of the fourth TDD subframe configuration at the first base station in response to the estimated interference exceeding a threshold.

15. The first base station of claim 13 wherein the first base station is configurable to perform interference mitigation for at least a portion of the subframes at the first base station in response to the estimated interference exceeding a threshold.

16. The first base station of claim 11, wherein the first base station is configurable to receive information identifying a fifth time TDD subframe configuration associated with a third base station.

17. The first base station of claim 6, wherein the first base station is configurable to acknowledge receipt of the information identifying the fifth TDD subframe configuration in response to identifying the third base station as a strong interferer.

18. The first base station of claim 17, wherein the first base station is configurable to receive information indicating modification of the fifth TDD subframe configuration to a sixth TDD subframe configuration.

19. The first base station of claim 18, wherein the first station is configurable to use at least a portion of the sixth TDD subframe configuration at the first base station in response to estimated interference from the third base station exceeding a threshold.

20. The first base station of claim 18, wherein the first base station is configurable to perform interference mitigation for at least a portion of the subframes at the first base station in response to the estimated interference from the third base station exceeding a threshold.
